(19) United States
(12) Patent Application Publication
(10) Pub. No.: US 2006/0176705 A1
(43) Pub. Date: Aug. 10, 2006

(54) Lighting Fixture

(76) Inventor: Giampaolo Targetti, Florence (IT)

Correspondence Address: WOLF BLOCK SCHORR AND SOLIS-COHEN LLP, 250 PARK AVENUE, NEW YORK, NY, 10177, US

(21) Appl. No.: 10/550,370

(22) PCT Filed: Sep. 7, 2004
(86) PCT No.: PCT/IT04/00480

§ 371 Date: Sep. 19, 2005

(30) Foreign Application Priority Data
Sep. 10, 2003 (IT) FI2003A000235

(51) Int. Cl. F21V 19/00; F21V 21/00

(52) U.S. Cl. 362/365; 362/368; 362/382

(57) ABSTRACT

A recessed lighting fixture with a device for quickly mounting or dismounting the lamp is disclosed. The device comprises an annular body having a front edge defining an aperture with dimensions generally greater than the diameter of the lamp. Flexible retaining members extend radially from the front edge at the aperture, suitable for holding the body at the lamp laterally. At least a pair of radial projections extend internally from the edge and define a span having a width generally smaller than the diameter of the lamp, such that the edge rests against the radial projections and is forced against them by the flexible retaining members.

### FIELD OF THE INVENTION

The present invention relates generally to lighting fixtures and more particularly refers to a lighting fixture of the recessed or downlight type with a device for quick mounting or dismounting of the lamp.

### DESCRIPTION OF THE PRIOR ART

It is known that in lighting fixtures intended for recessing in support panels, such as for example those used to form a ceiling or a partition wall, appropriate devices have to be provided to allow accessibility of the lamp so as to facilitate mounting and dismounting thereof. In some cases rings are used, attached to the support structure by means of screws and on which the edge of the lamp rests. In other cases elastic rings of the open type are inserted in the seat of the lamp to prevent it from coming out. In this case, two small adjacent arms which extend perpendicular from the ring opening are adjusted in order to remove the lamp. Still in other cases elastic thread-like elements are used with internally projecting protuberances on which the edge of the lamp rests.

A common feature of the abovementioned solutions, and others available on the market, is the unattractive appearance and, although they serve their purpose, thee are considered unsatisfactory. Therefore the need is greatly felt for a system of rapid assembly and disassembly of a lamp in a recessed lighting fixture which meets requirements both of good service and attractive appearance.

### OBJECTS AND SUMMARY OF THE INVENTION

The object of the present invention is to provide a lighting fixture particularly of the recessed type, wherein a system of rapid assembly and disassembly of the lamp is provided so as to facilitate maintenance of the fixture, without impairing the appearance of the fixture.

A particular object of the invention is to provide a fixture of the type mentioned above wherein the lamp can be disassembled by a light, eccentric pressure on its glass without having to remove any locking element.

A further object of the present invention is to provide a lighting fixture of the type mentioned above wherein no tool is required for assembling the lamp.

These objects are attained with the recessed lighting fixture with a system of quick mounting and dismounting of the lamp according to the present invention which comprises: an annular body with a front edge defining an aperture with dimensions larger than the diameter of the lamp; flexible retaining means extending radially from said edge at the aperture suitable for holding the body of said lamp laterally; and at least one pair of radial projections extending internally from said edge and defining a span with width smaller than the diameter of the lamp.

In this way the lamp is firmly locked in its proper position in the lighting fixture between the radial projections on which it rests with its edge and the flexible retaining means which force it against said projections. Moreover a light pressure exerted eccentrically on the glass of the lamp is sufficient to make it come out of the fixture, and with an equally simple operation of slight tilting and pressure against the flexible retaining means it is possible to position the lamp in the fixture.

### BRIEF DESCRIPTION OF THE DRAWINGS

Further features and advantages of the lighting fixture according to the present invention will be made clearer by the following description of one of its embodiments, given by way of a non-limiting example with reference to the accompanying drawings, wherein:

FIG. 1 shows in a side view the device for quickly mounting and dismounting the lamp of the lighting fixture according to the present invention;

FIG. 2 is a plan view from above of the device of FIG. 1.

### DETAILED DESCRIPTION OF THE INVENTION

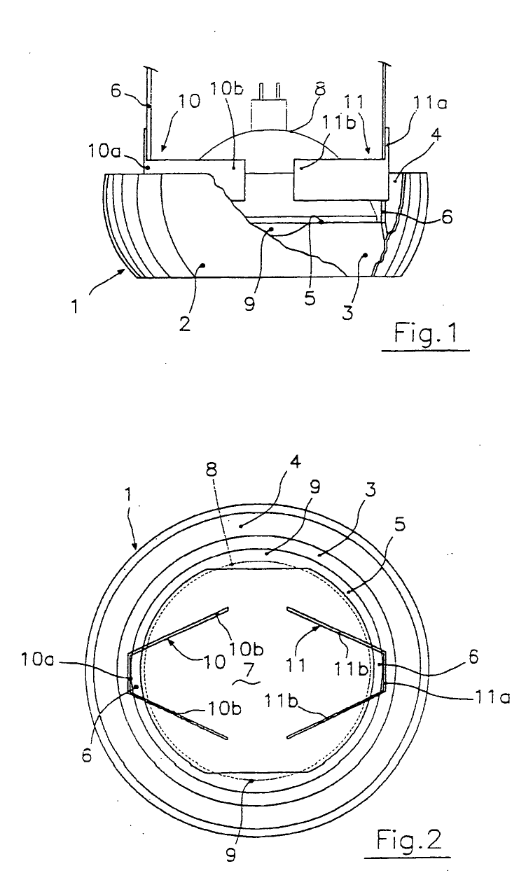

Referring to the foregoing figures, 1 denotes an annular body of the lighting fixture according to the invention. The annular body is shaped in such a way as to be housed in a seat of appropriate shape (not shown) which can be attached to the panel wherein the fixture is to be recessed. In particular the annular body 1 has a curved perimeter profile and the seat wherein it is engaged is correspondingly shaped, so as to be mobile inside said seat and in particular tiltable in relation to an axis perpendicular to the panel wherein the fixture is recessed. In the embodiment of the invention illustrated here, the annular body 1 is formed by an external wall 2, substantially tapered and with a rounded profile, and an internal wall 3 extending coaxially from one end of the external wall 2 and defining therewith a circular groove 4. The internal wall 3 has a front edge 5 which defines an aperture 7 wherein a lamp 8 is placed, illustrated by a narrow line in FIG. 1.

A pair diametrically opposed uprights 6 rise from the edge 5 and two projections 9 extend internally from the same edge 5, substantially at 90° with respect to the uprights 6.

The diameter of the aperture 7 defined by the edge 5 is slightly larger than the diameter of the lamp 8, while the span defined by the two projections 9 is slightly smaller than the diameter of the lamp 8.

The two uprights 6 support two flexible and substantially fork-shaped plate elements 10 and 11. More particularly the two plate elements are each formed by a base 10a (11a) and by a pair of wide apart arms 10b (11b). The bases 10a, 11a of the plate elements 10 and 11 are connected to the uprights 6 in any known manner, for example by screws, adhesive or clamping, while the two pairs of arms 10b and 11b extend diametrically one towards the other.

In normal operating conditions the lamp 8 rests with its front edge on the two radial projections 9 and is forced against them by the two pairs of wide apart arms 10b and 11b acting sideways thereon, so that the lamp is firmly locked inside the annular body 1. FIG. 2 illustrates with a dotted line the plan profile of the lamp 8 which rests on the radial projections 9.

When it is necessary to disassemble the lamp 8, it is sufficient to exert a light eccentric pressure on the glass of the lamp, preferably near one of the two radial projections, so as to cause its disengaging from the other radial projection and therefore cause it to come out of the annular body 1, its diameter being slightly smaller than the diameter of the aperture 7 defined by the edge 5.

When however the lamp 8 has to be mounted, it is sufficient to perform the previous operations in reverse, first inserting the lamp in the aperture 7, making sure that it is kept slightly tilted so that it can be engaged first on one and then also on the other of the two radial projections 9 and at the same time exerting a slight pressure to allow bending of the arms lob, lib to a sufficient extent to allow tilted insertion of the lamp 8.

To allow the lamp to be oriented, the two uprights can be formed with a pin engaged with a slotted guide, according to a common configuration in the art and therefore not shown. Alternatively two uprights can simply be made integral with the seat for housing the annular body so that the lamp is fixed.

In addition to the fork-shaped flexible laminar elements, as described above, the flexible retaining means can take on any shape suitable for ensuring an elastic thrust on the sides of the lamp which can be overcome with a moderate yet sufficient force for pressing the lamp against the radial projections 9 and firmly keeping it in a position of use.

Variations and/or modifications may be made to the recessed lighting fixture with a device for quick mounting and dismounting of the lamp according to the present invention, without thereby departing from the scope of the invention as set forth in the annexed claims

What is claimed is:

1. A recessed type lighting fixture with a device for removably mounting the lamp, which comprises:
an annular body with a front edge defining an aperture having a diameter generally larger than that of the lamp;
a flexible retainer member extending radially from the edge at the aperture, suitable for holding the body of the lamp laterally; and
at least one pair of radial projections extending internally from the edge and defining a span having a width generally smaller than the diameter of the lamp, such that the edge rests against the projections, the flexible retaining members biasing the edge against the projections.

2. The lighting fixture set forth in claim 1, wherein two diametrically opposed uprights extend from the edge to where the flexible retaining member is attached.

3. The lighting fixture set forth in claim 1, wherein the flexible retaining member comprises a pair of fork-shaped plate elements, each being formed by a base, integral to the edge, and a pair of widely spaced apart arms extending radially towards one another.

4. The lighting fixture set forth in claim 3, wherein the respective bases of the plate elements are attached to the uprights.

5. The lighting fixture set forth in claim 1, wherein the radial projections are positioned approximately 90° relative to the uprights.

6. The lighting fixture set forth in claim 1, wherein the annular body is suitable for engaging a corresponding seat integral to the panel, the fixture being recessed, and mounted so as to be oriented in the seat.

7. The lighting fixture set forth in claim 1, wherein the annular body is formed by an external wall and an internal wall extending coaxially from one end of the body and ending at the edge.
